(19) United States
(12) Patent Application Publication
(10) Pub. No.: US 2023/0079612 A1
(43) Pub. Date: Mar. 16, 2023

(54) System and Method for Computer Security

(71) Applicant: Paul Maszy, Rosenberg, TX (US)

(72) Inventor: Paul Maszy, Rosenberg, TX (US)

(21) Appl. No.: 17/474,031

(22) Filed: Sep. 13, 2021

(51) Int. Cl. H04L 29/06

(52) U.S. Cl. CPC H04L 63/145; H04L 63/20; H04L 63/102; H04L 63/1416; H04L 63/1425

(57) ABSTRACT

Disclosed is a system and method for computer security. The system provides preemptive security. That is, the system checks all web-based content and e-mail content in near real time before allowing the system access to the content.

### CROSS-REFERENCE TO RELATED APPLICATIONS

Not Applicable

### FEDERALLY SPONSORED RESEARCH/DEVELOPMENT

Not Applicable

### BACKGROUND

### Field

The present invention relates to a system and method of computer security.

### 2. Background

As more and more activities become wide area network based, such activities become targets for both criminal and non-criminal, but still intrusive, behavior. Accordingly, security of such activity becomes increasingly important.

The existing threats include several types of viruses, ransomware, spyware, malware, spam, worms, and botnets. Counters to every threat exist is some form or another. However, many of these counters have drawbacks. First, the counter may be a fix after the fact. For example, common virus checkers look for the code of a known virus. Of course, the virus may only be found if it exists on the computer, that is, the computer is already infected. Depending on the type of virus, by the time the virus checker identifies the virus, some irreparable damage may already have been done. This means that after the fact security may not be effective in actually providing security.

Additionally, most of the security software for computers is installed on an end user’s device. Because there are multiple types of threats, often multiple security programs must be installed to counter the threats. Thus, the individual programs running to counter threats may be numerous, bogging down the central processing unit, and slowing the operation of other programs. Further, as the number of viruses grow, so must the library of the virus checker. This means that the library of viruses only grows, consuming more and more of the storage available. Thus, traditional counters to computer security threats both consume processor power and memory. The important, but secondary goal of security begins to take over the entire operation of the computer. This takeover pushes aside the main operations of the computer.

Some attempts have been made to change the paradigm of computer security software. For example, rather than virus checking programs with large libraries, software has been created which essentially observes the operation of programs. These programs contain algorithms with allow the program to identify software running on the machine which fits the profile of a threat. The security software can then act to remove the threat. Although this type of security software solves the problem of large virus libraries, it does not solve the problem of only being able to check for a security breach once that security breach has already occurred.

For the foregoing reasons, there is a need for a system which can provide a solution which prevents infection while retaining a light footprint on the end user’s machine.

### BRIEF SUMMARY

Disclosed herein is a system for providing computer security. The system for proving computer security may include a first computer. The first computer may be connected to a network. The first computer may include instructions stored on a first memory and executed on a first processor. The instructions may provide a first user profile for terminal access. The system may further include a second computer. The second computer may be in communication with the first computer through the network. The second computer may include a first memory which may store executable instructions. The second computer may further include a first processor. The first processor may execute the executable instructions. They first processor may be electrically connected to the first memory. The system may further include a first set of executable instructions. The first set of executable instructions may be stored in the first memory and may be executable on the first processor. The first set of executable instructions may analyze in near real time a URL and links to additional URLs at the URL navigated to by a user using the second computer. The first set of instructions may isolate the URL, may execute any code at the URL, and may follow the links to the additional URLs and may execute any code at the additional URLs. The system may further include a second set of executable instructions. The second set of executable instructions may be stored on the first memory and may be executable on the first processor. The second set of executable instructions may analyze in near real time any incoming e-mail and any attachments to the e-mail sent to an account which is part of the first user profile. The second set of executable instructions may isolate the e-mail, may execute any code embedded in the e-mail, any code executable in any attachment to the e-mail, and may follow any URL links contained within the e-mail and may execute any code found at the linked URL. When a threat is detected in the URL or the links to additional URLs or when a threat is detected in any incoming e-mail or any attachments to or links embedded in the e-mail, the first set of executable instructions or the second set of executable instructions may remove access to the URL, the additional links, e-mail, attachment, or URL links contained within the email containing the threat.

Further disclosed herein is a method for providing computer security. The method may include providing a first computer. The first computer may be connected to a network. The first computer may include instructions stored on a first memory. The instructions may be executed on a first processor. The instructions may provide a user profile for terminal access. The method may further include placing a second computer in communication with the first computer through the network. The second computer may include a first memory. The first memory may store executable instructions. The second computer may further include a first processor. The first processor may execute the executable instructions. The first processor may be electrically connected to the first memory. A first set of executable instructions may be stored in the first memory and may be executable on the first processor. The first set of instructions may analyze in near real time a URL and links to additional URLs at the URL navigated to by a user using the second computer. The first set of instructions may isolate the URL, may execute any code at the URL, and may follow the links to the additional URLs and may execute any code at the additional URLs. The second computer may further include a second set of executable instructions stored on the first memory. The second set of executable instructions may be executable on the first processor. The second set of instructions may analyze in near real time any incoming e-mail and any attachments to the e-mail sent to an account which is part of the user profile. The second set of executable instructions may isolate the e-mail, may execute any code embedded in the e-mail, any code executable in any attachment to the e-mail, and may follow any URL links contained within the e-mail and may execute any code found at the linked URL. When a threat is detected in the URL or the links to additional URLs or when a threat is detected in any incoming e-mail or any attachments to or links embedded in the e-mail, the first set of executable instructions or the second set of executable instructions may remove access to the URL, the additional links, e-mail, attachment, or URL links contained within the email containing the threat.

Further disclosed herein is a system for providing computer security. The system may include a computer terminal connected to a network. The connection may use a virtual private network connection. The system may further include a server. The server may be connected to the computer terminal through the network. The system may further include a virtual computer running on the server. The virtual computer may duplicate the network operations of the computer terminal. The virtual computer may analyze, in near real time, a URL and any links to additional URLs at the URL navigated to by a user using the computer terminal. The virtual computer may execute any code at the URL, and may follow any links to additional URLs and may execute any code at the additional URLs. The virtual computer may further analyze, in near real time, any incoming e-mail and any attachments to the e-mail sent to an account, which is part of a user profile executing on the computer terminal. The virtual computer may isolate the e-mail, may execute any code embedded in the e-mail, and may executing any code in any attachment to the e-mail, and may follow any URL links contained within the e-mail and may execute any code found at the URL. When a threat is detected at the URL or any additional of the additional URLs, or when a threat is detected in any incoming e-mail or any attachments to or links embedded in the e-mail, a set of executable instructions, stored on a memory of the server and executing on a processor of the server, may remove access to the URL, link, e-mail, or attachment containing the threat.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a schematic diagram of the system; and

FIG. 2. shows a flowchart of the system’s operation.

### DETAILED DESCRIPTION

The detailed description set forth below in connection with the appended drawings is intended as a description of the presently preferred embodiment of system and method to control devices through powerline control, and is not intended to represent the only form in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

Disclosed is a system and method to provide computer security. The system is focused on retaining a minimum footprint at the end user level, while providing superior security. In order to provide superior security, aspects of the disclosure include computer instructions, in combination with hardware, which are proactive. That is, aspects of the disclosure seek to identify security threats and disable the security threat’s access to the end user’s computer system.

Further aspects of the disclosure provide for second aspect of protection, specifically containment in the case that a breach of device security does occur. The system accomplishes containment by including a first computer which stores a user profile. The user profile may be accessed by a second computer over a network, and the user profile may be employed in real time by the second computer. If the second computer experiences a breach of security, the first computer may shut down access to itself by the second computer. The shutdown of access limits the breach to the confines of the second computer of the system. The user profile may be redeployed later on another machine connected to the network, and, specifically, the first computer.

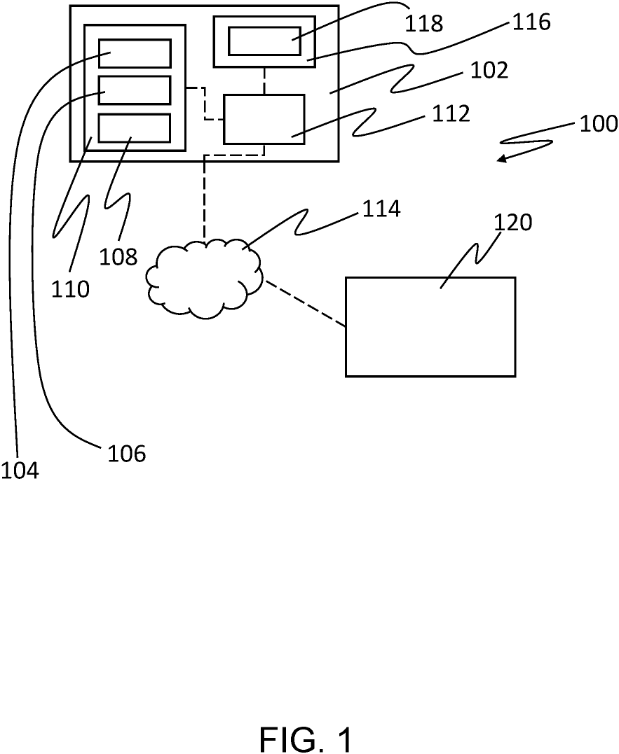

More specifically, as shown in FIG. 1, the system 100 may include a first computer 102. The first computer 102 may include a first set of instructions 104, a second set of instructions 106, and a third set of instructions 108 stored in memory 110. The memory 110 may be a single location or multiple locations. For example, the instructions 104, 106, 108 may be stored on a single drive. Alternatively, the instructions 104, 106, 108 may be stored on two or more drives. Further, the first computer 102 may be a single machine or a plurality of machines working in coordination.

The memory 110 may be electrically connected to one or more processors 112, with the instructions 104, 106, and 108 being executable on the one or more processors 112. The one or more processors may, in turn, be electrically connected to a network 114.

The network 114 may be a local area network (LAN) a wide area network (WAN) or a combination of LAN and WAN. The WAN may be the internet. A virtual private network (VPN) may be used when the internet is the WAN in order to provide additional network security.

The first computer 102 may further include storage 116 for one or more user profiles 118. Although a single user profile 118 is shown in FIG. 1, it is to be understood that two or more user profiles 118 may be stored in a memory 116 on the first computer 102. The user profile 118 may include an operating system and one or more applications. The user profile 118 may be accessed through the network 114 by having the required credentials. The credentials may be a username and password or other data. The credentials may include a two-part authentication factor. For example, the two-part authentication may include a code sent to a phone or e-mail account. Regardless of the exact form of the two-factor authentication, in addition to the VPN, the two-factor authentication may provide initial security to the system 100.

The first computer 102 may be a server, or a group of servers which are operatively connected. Alternatively, the first computer 102 may be a cloud computing system. Still further alternatively, the first computer 102 may be a desktop computer.

The user profile 118 may have a standard set of applications in a predetermined configuration on an operating system. Therefore, the first computer 102 may include computer instructions that allow a user with administrative rights to create a user profile 118 with a single command. The administrator may have to include data which is specific to the user profile, by way of example and not limitation, an email address, as part of the command. In a similar manner, a user with administrative rights may delete a user profile form the first computer 102 using a single command. Alternatively, the user profile 118 may not be entirely deleted, but may be deactivated, or have access removed, by a single command.

A second computer 120 may access one of the one or more user profiles 118 on the first computer 102 through the network 114. Because of the distribution of software on the system, the second computer 120 may have relatively low processing power, and still meet user requirements. By way of example and not limitation, the second computer 120 may be a Chromebook or a Raspberry Pi. The relatively low cost of these machines also provides a form of security for the system. Because these types of machines are inexpensive, they may be disposed of and replaced. Contrast this with other systems including relatively higher cost user machines. When a user machine is compromised on these other systems, the only remedy which makes financial sense is to fix the end user machine and return it to the end user. In many state-of-the-art systems, a end user machine with relatively high processing power and memory is required because much of the security software is running off of the end user machine. This is not the case in the disclosed system as the security software is part of the user profile and runs, at least in part, in a distributed fashion. Alternatively, the second computer 120 may be a mobile device, for example a tablet computer or a smartphone.

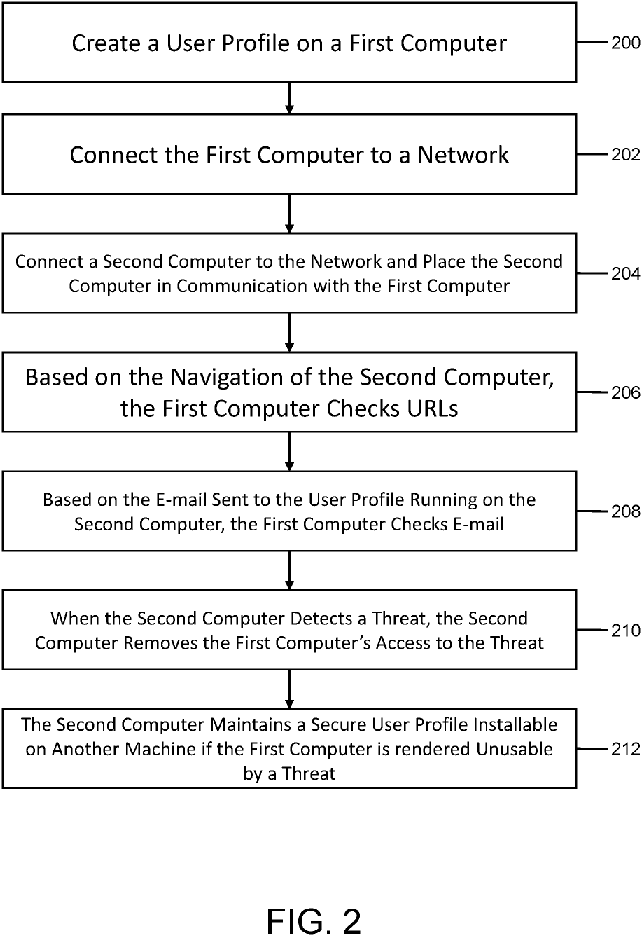

As shown in FIGS. 1 and 2, in operation, the system 100 may be initiated in a first step 200 by a user, and more specifically a user with administrative privileges creating a user profile 118 on the first computer 102. As discussed above, the user profile 118 on the first computer 102 may be accessed by an end user on a second computer 120 with the proper credentials for the user profile 118.

Step 200 describes connecting the first computer 102 to a network. As described above, the network may be a LAN or WAN or combination of both a LAN and WAN, or pluralities of LANs and WANs. The network may be made with wireless or wired connections or a combination of wired and wireless connections. Alternatively, Steps 200 and 202 may be reversed so that the user profile 118 is created after the first computer 102 is connected to the network 114. Thus, it will be understood that Steps 200 and 202 are interchangeable in order.

In Step 204, an end user may connect the second computer 120 to the network 114. Once connected to the network 114, the second computer 120 may be placed in communication with the first computer 102. The communication may be established through an application which allows the ender user on the second computer 120 to provide required credentials to the first computer 102 in order to access the user profile 118. The application may be a stand-alone application or a web-based application. Once the user profile 118 has been accessed, the user profile begins to run a plurality of applications in a distributed manner across the first computer 102 and the second computer 120.

One of the plurality of applications may be an internet browser. Regardless of the precise internet browser chosen either by the administrator and made available for use in the user profile 118, the critical functionality for providing the security is the same. That is, all browsers allow a user to navigate to at least one universal record locator (URL) at a time. When the user navigates to a URL using the browser, the computer security automatically begins operation. However, it is to be understood that after a first URL is navigated to in a first tab, a second tab may be opened in the same browser, and a second URL navigated to in the second tab. Thus, two URLs may be open, one in each tab of the same browser. Each URL is navigated to at a different time, and analyzed in near real time when that URL is navigated to, regardless of tab or browser used.

The security may be provided by a plurality of sets of instructions stored on the first computer 102. A first set of instructions may operate during Step 206, as shown in FIG. 2. The operation of a first set of instructions 104 may be triggered by the navigation of the second computer 120 to a new URL. When the browser running on the second computer 120 navigates to a new URL, the first set of instructions 104 may begin to execute on a processor.

The first set of instructions 104 uses the URL determined for navigation to by the user to run a series of tests. A first portion of the first set of instructions 104 reviews the code present at the URL in near real time. If there are links to additional URLs, then the first set of instructions 104 reviews the code at those URLs as well. A second portion of the first set of instructions 104 removes access to any code which the first set of instructions 104 determines is potentially harmful to the second computer 120, or which may even not be harmful, but are a breach of computer security. The first set of instructions 104 does not allow any part of the webpage defined by the code at the URL to be available to the user until that portion of the code at the URL has been evaluated by the first set of instructions 104.

By way of example, and not limitation, a website at a URL may include an application, an advertisement including a link for a different URL, and a link to another webpage which is part of the same domain. The first set of instructions 104 may first examine the application at the URL. The first set of instructions 104 examines the code of the application to determine the code’s effects. Thus, the effects of the application may be determined without a requirement for the second computer 120 to run the code. Again, if the first set of instructions 104 did not operate in this way, the application would be run by a user operating the second computer, and if the code of the application posed a security threat to the second computer 120, the existence of the threat can only be determined by state-of-the-art systems once the security of the second computer 120 is breached. In contrast, the first set of instructions 104 is able to determine if the application poses any kind of threat before the application is run on the second computer 120, providing greater security, and potentially, cost savings over state-of-the-art systems.

A second portion of the first set of instructions 104 prevents the code found to pose a security from being accessible by the user of the second computer 120. When the security threat is contained in an application as is described in the preceding paragraphs, the access to the application may be removed by not displaying a graphical control surface, for example, a “start” button. Regardless of the precise label, the graphical control surface may be an area on the screen, typically designated by a graphic, that allows a user to initiate operation of the application by clicking on the graphical control surface. The second portion of the first set of instructions 104 may remove access to the graphical control surface by removing the graphic, disabling the link or both. Disabling the graphic control surface removes the possibility of initiating the security threat found by the first portion of the first set of instructions 104 by not allowing the application to be run. Thus, the system proactively prevents a security threat from being placed on the second computer 120.

As mentioned above, and as is familiar to essentially anyone who has navigated on the internet, many webpages include advertisements. Almost all of these advertisements include a link. The link operates to navigate the browser to a URL indicated by the link. In order to activate the link, again, a graphical control surface may be used. In many cases the graphical control surface is the entire screen area occupied by the advertisement. Said another way, clicking anywhere on the advertisement will navigate the browser to another URL contained in the data for the advertisement.

The first set of instructions 104 may include a third portion and a fourth portion. The third portion of the first set of instructions 104 may navigate to the URL contained in the browser and review the code at that URL. If there are further URL links at the new URL, he third portion may investigate those links until an end of the links is reached. Said another way, the third portion will continue review of the code at successive URLs until a URL is reached which contains no further links.

Alternatively, the third portion may only navigate to any link found at the first URL and review the code at any link found at the first URL and stop the code review there. It will be understood that should a user navigate to a second URL, the review process will repeat. Of course, the process will repeat for any new URL navigated to. Essentially, the code at any new URL will be reviewed before the user can access it.

If the review of code at the URL to be navigated to includes code that either may be accessed once on the website located at the URL or that executes upon navigating to the URL, and presents a security risk, either the content will be blocked as described above, or the user will be prevented from navigating to the URL. In the case where code is found on the page which may be accessed by the user, the access to the code on the website will be blocked by the first set of instructions 104. In the case that the URL includes code that will executed automatically upon navigating to the URL, the first set of instructions 104 will not allow the user to navigate to the URL, with the browser remaining on the current URL.

The second set of instructions 106 reviews e-mail accessed by the user. The email may be reviewed in combination with the second set of instructions when e-mail is accessed through a web-based e-mail application, for example, Google’s Gmail or Microsoft’s Outlook web access. When a web-based application, the second set of instructions may be called by the first set of instructions.

Alternatively, when the user accesses an e-mail application, by way of example and not limitation, Microsoft’s Outlook, the second set of instructions will review any e -mail messages which the user accesses for links to URLs, HTML content, or other executable code in the body of the e-mail message. If any links or code is detected, the code is reviewed as described above, and if a threat is detected, access is removed by not allowing the user to click on the link or otherwise execute the code.

The second set of instructions 106 will further review any attachments to e-mail messages for threats. Threats are often sent in attachments to e-mails. The second set of instructions reviews the code in the attached file. The second set of instructions 106 is able to review any file type including, without limitation, word processing documents, presentation documents, spreadsheets, graphics, and photo files. While each of these file types may have a structure particular to that type of file, the second set of instructions 106 is able to differentiate between them and account for the differences when reviewing the attached file for threats.

If a threat is detected by the second set of instructions 106 in an attached file, the ability to access the file is removed. The accessed may be removed by blocking the link to access the file. Alternatively, access to the file may be removed by deleting the file entirely. The second set of instructions 106 may delete the file by moving the file to the trash on the computer. Alternatively, the second set of instructions 106 may delete the file permanently.

A third set of instructions 108 may monitor the operation of the second computer 120. The third set of instructions 108 may monitor which applications are being used by the computer and for how long. In addition to monitoring the application in use, for a web browser, the third set of instructions 108 may further monitor which URLs are open and for how long. The monitoring done by the third set of instructions 108 results in the data described above being recorded as additional data in the user profile 118.

The above description is given by way of example, and not limitation. Given the above disclosure, one skilled in the art could devise variations that are within the scope and spirit of the invention disclosed herein, including various ways of triggering the operation of the instructions. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A system for providing computer security, comprising:
a first computer, the first computer connected to a network and the first computer including instructions stored on a first memory and executed on a first processor which provide a first user profile for terminal access;
a second computer in communication with the first computer through the network, the second computer including:
a first memory for storing executable instructions;
a first processor for executing the executable instructions electrically connected to the first memory;
a first set of executable instructions stored in the first memory and executable on the first processor which analyze in near real time a URL and links to additional URLs at the URL navigated to by a user using the second computer by isolating the URL, executing any code at the URL, and following the links to the additional URLs and executing any code at the additional URLs; and
a second set of executable instructions stored on the first memory and executable on the first processor which analyze in near real time any incoming e-mail and any attachments to the e-mail sent to an account which is part of the first user profile by isolating the e-mail, executing any code embedded in the e-mail, any code executable in any attachment to the e-mail, and following any URL links contained within the e-mail and executing any code found at the linked URL;
wherein, when a threat is detected in the URL or the links to additional URLs or when a threat is detected in any incoming e-mail or any attachments to or links embedded in the e-mail, the first set of executable instructions or the second set of executable instructions removes access to the URL, the additional links, e-mail, attachment, or URL links contained within the email containing the threat.

2. The system of claim 1, wherein the network connection is a virtual private network connection.

3. The system of claim 1, wherein the second computer is a virtual machine.

4. The system of claim 1, further comprising a third computer connected to the network.

5. The system of claim 4, wherein the second computer is in communication with the first computer and third computer through the network.

6. The system of claim 5, wherein the first set of executable instructions stored in the first memory and executable on the first processor analyze in near real time another URL and links to additional URLs at the other URL navigated to by another user using the third computer by isolating the other URL, executing any code at the other URL, and following the links to the additional URLs and executing any code at the additional URLs; and
the second set of executable instructions stored on the first memory and executable on the first processor analyze in near real time any incoming e-mail and any attachments to the e-mail sent to another account which is part of a second user profile by isolating the e-mail, executing any code embedded in the e-mail, any code executable in any attachment to the e-mail, and following any URL links contained within the e -mail and executing any code found at the linked URL;
wherein, when a threat is detected in the URL, other URL or the links to the additional URLs or any links to the additional URLs at the other URL or when a threat is detected in any incoming e-mail of the first user profile or the second user profile or any attachments to or links embedded in the e-mail of the first user profile or the second user profile, the first set of executable instructions or the second set of executable instructions removes access to the URL, other URL, the additional links to the URL or other URL, e-mail to the first user profile account or second user profile account, attachment, or URL links contained within the email to the first user profile account or the second user profile account containing the threat.

7. The system of claim 1, wherein the links to the additional URLs are in one or more browser windows or tabs.

8. A method for providing computer security, comprising:
providing a first computer, the first computer connected to a network and the first computer including instructions stored on a first memory and executed on a first processor which provide a user profile for terminal access;
placing a second computer in communication with the first computer through the network, the second computer including:
a first memory for storing executable instructions;
a first processor for executing the executable instructions electrically connected to the first memory;
a first set of executable instructions stored in the first memory and executable on the first processor which analyze in near real time a URL and links to additional URLs at the URL navigated to by a user using the second computer by isolating the URL, executing any code at the URL, and following the links to the additional URLs and executing any code at the additional URLs; and
a second set of executable instructions stored on the first memory and executable on the first processor which analyze in near real time any incoming e-mail and any attachments to the e-mail sent to an account which is part of the user profile by isolating the e-mail, executing any code embedded in the e-mail, any code executable in any attachment to the e-mail, and following any URL links contained within the e-mail and executing any code found at the linked URL;
wherein, when a threat is detected in the URL or the links to additional URLs or when a threat is detected in any incoming e-mail or any attachments to or links embedded in the e-mail, the first set of executable instructions or the second set of executable instructions removes access to the URL, the additional links, e-mail, attachment, or URL links contained within the email containing the threat.

9. The method of claim 8, wherein the network connection is a virtual private network connection.

10. The method of claim 8, wherein the second computer is a virtual machine.

11. The method of claim 8, wherein the links to additional URLs are in one or more browser windows or tabs.

12. The method of claim 8, further comprising connecting a third computer to the network, and placing the third computer in communication with the second computer, the first set of executable instructions stored in the first memory and executable on the first processor analyze in near real time another URL and links to additional URLs within the website at the other URL navigated to by another user using the third computer by isolating the other URL, executing any code at the other URL, and following the links to additional URLs within the website and executing any code at websites contained in the links to additional URLs; and
the second set of executable instructions stored on the first memory and executable on the first processor analyze, in near real time, any incoming e-mail and any attachments to the e-mail sent to another account which is part of a second user profile by isolating the e-mail, executing any code embedded in the e-mail, any code executable in any attachment to the e-mail, and following any URL links contained within the e -mail and executing any code found at the URL;
wherein, when a threat is detected in the URL, other URL or the links to the additional URLs or any links to the additional URLs at the other URL or when a threat is detected in any incoming e-mail of the first user profile or the second user profile or any attachments to or links embedded in the e-mail of the first user profile or the second user profile, the first set of executable instructions or the second set of executable instructions removes access to the URL, other URL, the additional links to the URL or other URL, e-mail to the first user profile account or second user profile account, attachment, or URL links contained within the email to the first user profile account or the second user profile account containing the threat.

13. A system for providing computer security, comprising:
a computer terminal connected to a network using a virtual private network connection;
a server connected to the computer terminal through the network;
a virtual computer running on the server;
wherein, the virtual computer duplicates the network operations of the computer terminal and the virtual computer analyzes, in near real time, a URL and any links to additional URLs at the URL navigated to by a user using the computer terminal by executing any code at the URL, and following the any links to additional URLs and executing any code at the additional URLs, and analyzes, in near real time, any incoming e-mail and any attachments to the e-mail sent to an account, which is part of a user profile executing on the computer terminal, by isolating the e-mail, executing any code embedded in the e-mail, and executing any code in any attachment to the e-mail, and following any URL links contained within the e-mail and executing any code found at the URL, and when a threat is detected at the URL or any additional of the additional URLs, or when a threat is detected in any incoming e-mail or any attachments to or links embedded in the e -mail, a set of executable instructions, stored on a memory of the server and executing on a processor of the server, removes access to the URL, link, e-mail, or attachment containing the threat.

14. The system of claim 13, wherein the computer terminal is a mobile device.

15. The system of claim 13, wherein the links to the additional URLs are in one or more browser windows or tabs.

16. The system of claim 13, wherein additional data regarding the user profile is recorded on the system.

17. The system of claim 13, wherein administrative rights for the user profile are maintained on the server.

18. The system of claim 17, wherein the user profile is created by a single command.

19. The system of claim 18, wherein the user profile may be deactivated by a single command.

20. The system of claim 13, wherein the user profile will run on a raspberry pi.
